(19) United States
(12) Patent Application Publication
(10) Pub. No.: US 2024/0157519 A1
(43) Pub. Date: May 16, 2024

(54) A SELF-ADJUSTING PIPE WRENCH TOOL

(71) Applicant: MACHT TOOLS PTY LTD, Runaway Bay (AU)

(72) Inventor: Steve DUDSON, Runaway Bay (AU)

(21) Appl. No.: 18/550,761

(22) PCT Filed: Mar. 17, 2022
(86) PCT No.: PCT/AU2022/050233

§ 371 Date: Sep. 15, 2023

(30) Foreign Application Priority Data
Mar. 17, 2021 (AU) 2021900762

(51) Int. Cl. B25B 13/50

(52) U.S. Cl. CPC B25B 13/505

(57) ABSTRACT

A self-adjusting pipe wrench tool has a handle, a heel jaw at a distal and of the handle, the heel jaw defining a curved grip face, and an adjustable jaw pivotally coupled to the handle at a pivot point, the adjustable jaw defining a planar proximal grip face and a planar distal grip face at an angle to the proximal pipe face. The self-adjusting pipe wrench tool has particular geometry to maximise the operational gripping diameter range thereof.

### FIELD OF THE INVENTION

This invention relates generally to a self-adjusting pipe wrench tool and, more particularly, to a self-adjusting pipe wrench tool having particular geometry to optimise the gripping thereof.

### SUMMARY OF THE DISCLOSURE

There is provided herein a self-adjusting pipe wrench tool comprising a handle and a heel jaw at a distal end of the handle. The heel jaw defines a curved grip face. The wrench further comprises an adjustable jaw pivotally coupled to the handle at a pivot point. The adjustable jaw defines a planar proximal grip face and a planar distal grip face at an angle to the proximal grip face.

The wrench, and in particular the adjustable jaw, has a particular geometry maximising the operational gripping diameter and/or gripping diameter range of the wrench. For example, along a longitudinal axis of the handle when the adjustable jaw is closed, a ratio of a gap between the distal grip face and the curved grip face at the distal grip face and the pivot point is greater than 25%, preferably greater than 30%.

As such, for example, for variously sized wrenches having lengths ranging from approximately 18″-36″, the maximum/minimum griping diameter ratio may be between 3.2-1.6 respectively.

Furthermore, the wrench may comprise interchangeable componentry, including interchangeable heel and adjustable jaws.

Furthermore, the adjustable jaw may be biased close to assist ratcheting.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a perspective disassembled view of a self-adjusting pipe wrench tool in accordance with an embodiment;

FIG. 2 shows a side view of the tool;

FIG. 3 shows a top view of the tool; and

FIG. 4 shows a further side view of the tool.

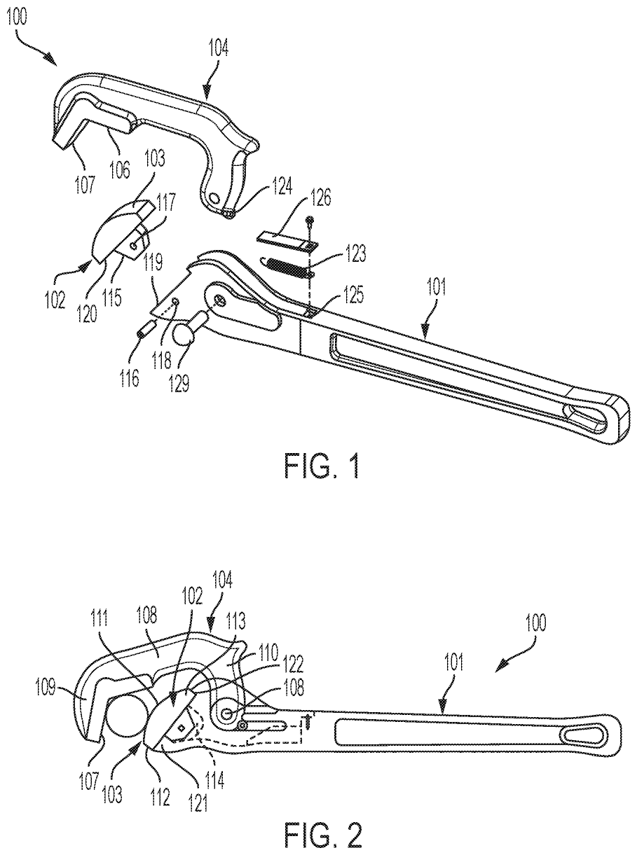

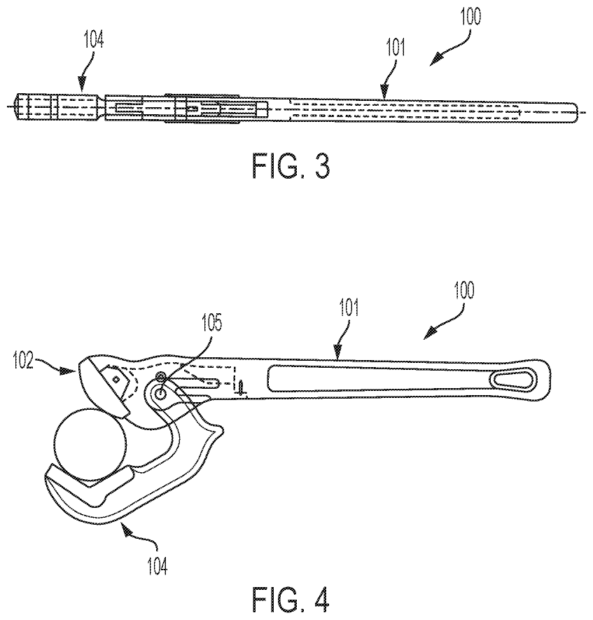

### DESCRIPTION OF EMBODIMENTS

A self-adjusting pipe wrench tool 100 comprises a handle 101. For orientational referencing, proximal and the like will be described as being towards the right-hand side of the wrench 100 given the orientation of FIG. 2 and a distal and the like will be described as being towards the left-hand side.

The wrench 100 comprises a heel jaw 102 at a distal end of the handle 101.

The heel jaw 102 defines a curved grip face 103. The curved grip face 103 may comprise grip teeth formations thereacross.

The wrench 100 further comprises an adjustable jaw 104 pivotally coupled to the handle 101 at a pivot point 105. The adjustable jaw 104 may comprise drop forged steel. The adjustable jaw 104 defines a planar proximal grip face 106 and a planar distal grip face 107 at an angle to the proximal grip face 106 which grips a pipe or similar at two points in opposition to the heel jaw 102. The distal grip face 107 may be at approximately 45° with respect to the proximal face 106.

The adjustable jaw 104 has a particular geometry to maximise the gripping diameter and/or gripping diameter operational range of the wrench 100. Specifically, with reference to FIG. 2, when the adjustable jaw 104 is closed, along a longitudinal axis defined by the handle 101 (preferably through the pivot point 105), a ratio of a gap between the distal grip face 107 and the curved grip face 103 and the distal grip face 107 and the pivot point 105 is greater than 30%. More preferably, the ratio is greater than 33%.

This ratio allows for a gripping diameter sizing, range and ratio between when the adjustable jaw 102 is closed as shown in FIG. 2 and when the adjustable jaw 104 is open as shown in FIG. 4 for the following exemplary wrench sizes:

| Approx. Handle | Gripping Diameter | Max/min Griping Diameter |
|---|---|---|
| Length | Range (MM) | Ratio |
| 18″ | 25-80 | 3.2 |
| 24″ | 65-120 | 1.8 |
| 36″ | 95-155 | 1.6 |

FIGS. 2 and 4 shows the 24″ wrench wherein, in the more closed configuration in FIG. 2, the ratio of a gap between the distal grip face 107 and the curved grip face 103 and the distal grip face 107 and the pivot point 105 is approximately 34% and the gripping diameter is approximately 65 mm whereas in the open configuration shown in FIG. 4, the gripping diameter is approximately 120 mm.

The adjustable jaw 104 comprises a midsection 108, a distal section 109 at an angle to the midsection and a proximal section 110.

The proximal and distal grip faces 106, 107 may be defined at an inner juncture between the midsection 108 and the distal section 109. Furthermore, the proximal section 110 is substantially orthogonal with respect to the midsection 108 and is pivotally coupled to the handle 101.

The proximal grip face 106 may have a length of approximately the same as that of the distal grip face 107 and the proximal grip face 106 may be approximately half the length of the midsection 108. In other words, the midsection 108 is relatively elongate to place the proximal and distal grip faces 106, 107 relatively far from the pivot point 105, thereby increasing the operational grip diameter range of the wrench 100.

The curved grip face 103 may be orientated approximately 45° with respect to the longitudinal axis of the handle 101. In other words, the curved grip face 103 may be at approximately 45° with respect to the longitudinal axis at a midpoint 111 thereof.

The curved grip face 103 may have a curvature which is substantially orthogonal to the longitudinal axis at a distal end 112 thereof. Furthermore, the curvature may go through almost 90°, such as approximately through 80° such that the curvature is almost parallel to the longitudinal axis at a proximal end 113 thereof.

The heel jaw 102 may be replaceably affixable to the handle 101. The heel jaw 102 may comprise an alloy.

The handle 101 may define a recess 114 into which a rear tab 115 of the heel jaw 102 is insertable and securable with a through pin 116. The rear tab 115 may comprise a central aperture 117 therethrough which collocates with corresponding side apertures 118 of the handle 101 when the insertion tab 115 is inserted into the recess 114.

The handle 101 may define a planar heel jaw bearing face 119 which seats a rear planar face 120 of the heel jaw 102. The planar heel jaw bearing face 119 defines an opening to the recess 114 therein.

The planar heel jaw bearing face 119 may be approximately 45° with respect to the longitudinal axis of the handle 101.

As shown in FIG. 2, a distal end 121 of the planar heel jaw bearing face 119 may collocate with the distal end 112 of the heel jaw 102 thereby forming a continuous transition thereacross.

Furthermore, a proximal end of the planar heel jaw bearing face 119 may define a proximal edge 122 which engages against the proximal end 113 of the heel jaw 102.

The adjustable jaw 104 may be biased towards a closed position by a biasing mechanism. The biasing mechanism comprises a compartmentalised tension spring 123 operable between the handle 101 and a proximal end of the adjustable jaw 104.

The adjustable jaw 104 may comprise a tension spring engaging aperture 124 and the handle 101 may comprise an opposite tension spring engaging aperture 125 between which the tension spring 123 is tensioned. The tension spring 123 may be concealed beneath a cover plate 126.

The adjustable jaw 104 may be interchanged by removing pin 129. In embodiments, the same size handle 101 may be used with differently sized adjustable jaws 104 for various applications.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

The term “approximately” or similar as used herein should be construed as being within 10% of the value stated unless otherwise indicated.

1. A self-adjusting pipe wrench tool comprising:
a handle;
a heel jaw at a distal and of the handle, the heel jaw defining a curved grip face,
an adjustable jaw pivotally coupled to the handle at a pivot point, the adjustable jaw defining a planar proximal grip face and a planar distal grip face at an angle to the proximal grip face, wherein,
along a longitudinal axis defined by the handle, a ratio of a gap between the distal grip face and the curved grip face and the distal grip face and the pivot point is greater than a 30%.

2. The tool as claimed in claim 1, wherein the ratio is greater than 33%.

3. The tool as claimed in claim 1, wherein the distal grip face is approximately 45° with respect to the proximal grip face.

4. The tool as claimed in claim 1, wherein the adjustable jaw comprises:
a midsection,
a distal section at an angle to the midsection, the proximal and distal grip faces thereof being defined between the distal and midsections; and
a proximal section being substantially orthogonal to the midsection and being pivotally coupled to the handle.

5. The tool as claimed in claim 4, wherein the proximal grip face is approximately half the length of the midsection.

6. The tool as claimed in claim 1, wherein a max/min gripping diameter ratio is greater than 1.5.

7. The tool as claimed in claim 1, wherein a max/min gripping diameter ratio is approximately 1.6.

8. The tool as claimed in claim 7, wherein the minimum gripping diameter is approximately 95 mm and the maximum gripping diameter is approximately 155 mm.

9. The tool as claimed in claim 1, wherein a max/min gripping diameter ratio is greater than 1.6.

10. The tool as claimed in claim 1, wherein a max/min gripping diameter ratio is approximately 1.8.

11. The tool as claimed in claim 10, wherein the minimum gripping diameter is approximately 65 mm and the maximum gripping diameter is approximately 120 mm.

12. The tool as claimed in claim 1, wherein a max/min gripping diameter ratio is greater than 3.

13. The tool as claimed in claim 1, wherein a max/min gripping diameter ratio is approximately 3.2.

14. The tool as claimed in claim 13, wherein the minimum gripping diameter is approximately 25 mm and the maximum gripping diameter is approximately 80 mm.

15. The tool as claimed in claim 1, wherein the curved grip face has a curvature which is substantially orthogonal to the longitudinal axis at a distal end thereof.

16. The tool as claimed in claim 15, wherein the curvature is through more than 80°.

17. The tool as claimed in claim 15, wherein the curvature is at approximately 45° with respect to the longitudinal axis at a midpoint thereof.

18. The tool as claimed in claim 1, wherein the heel jaw is replaceably affixable to the handle.

19. The tool as claimed in claim 18, wherein the handle defines a recess into which a rear tab of the heel jaw is insertable and securable with a through pin.

20. The tool as claimed in claim 19, wherein the handle defines a planar heel jaw bearing face which seats a rear planar face of the heel jaw, the planar heel jaw bearing face having the recess therein.

21. The tool as claimed in claim 20, wherein the planar heel jaw bearing face is approximately 45° with respect to the longitudinal axis of the handle.

22. The tool as claimed in claim 20, wherein a distal end of the planar heel jaw bearing face collocates with a distal end of the heel jaw.

23. The tool as claimed in claim 20, wherein a proximal end of the planar heel jaw bearing face defines a proximal edge which engages against with a proximal end of the heel jaw.

24. The tool as claimed in claim 1, wherein the adjustable jaw is replaceably affixable to the handle with a through pin.

25. The tool as claimed in claim 1, wherein the adjustable jaw is biased towards a closed position by a biasing mechanism.

26. The tool as claimed in claim 25, wherein the biasing mechanism comprises a tension spring operable between the handle and a proximal end of the adjustable jaw.

27. The tool as claimed in claim 26, further comprising an affixable cover plate concealing the tension spring there underneath.

28. The tool as claimed in claim 1, wherein the adjustable jaw is interchangeable by removing a pin through the pivot point.

29. The tool as claimed in claim 28, wherein the pipe wrench tool comprises interchangeable adjustable jaws of different sizes.
